(19) United States
(12) Patent Application Publication
(10) Pub. No.: US 2025/0326607 A1
(43) Pub. Date: Oct. 23, 2025

(54) UNLOCKING DEVICE AND UNLOCKING METHOD OF ELEVATOR LANDING DOOR, AND ELEVATOR SYSTEM

(71) Applicant: Otis Elevator Company, Farmington, CT (US)

(72) Inventors: Jingri Nan, Shanghai (CN); Jun Luo, Shanghai (CN); Yong Zhao, Shanghai (CN); Min Wang, Shanghai (CN)

(21) Appl. No.: 19/184,444

(22) Filed: Apr. 21, 2025

(30) Foreign Application Priority Data
Apr. 23, 2024 (CN) 202410495876.1

(51) Int. Cl. B66B 13/14; B66B 5/02

(52) U.S. Cl. CPC B66B 13/14; B66B 5/027

(57) ABSTRACT

An unlocking device of an elevator landing door, an unlocking method of an elevator landing door, and an elevator system. The unlocking device of an elevator landing door includes a support rod; a pulley arranged on the support rod and wounded with a tension member; and an operating rod connected to a first end of the tension member, a second end of the tension member extending along a length direction of the operating rod after wounding around the pulley. The operating rod is provided with an actuating portion for an operator, after operating the operating rod to cause the actuating portion to engage an unlocking member of the elevator landing door, to unlock the elevator landing door by pulling the second end of the tension member to actuate the unlocking member through the actuating portion.

### FOREIGN PRIORITY

This application claims priority to Chinese Patent Application No. 202410495876.1, filed Apr. 23, 2024, and all the benefits accruing therefrom under 35 U.S.C. § 119, the contents of which in its entirety are herein incorporated by reference.

### TECHNICAL FIELD OF INVENTION

The present disclosure relates to the technical field of elevators, in particular to an unlocking device of an elevator landing door, an unlocking method of an elevator landing door, and an elevator system.

### BACKGROUND OF THE INVENTION

Elevators have been widely used in modern society. The installation of elevators in many places can bring great convenience to people's work, life, and travel. Elevator shaft is a vertical passage arranged in a building to allow an elevator to move up and down. The portion of the shaft located below the lowest landing where the elevator car operates is the shaft pit, which generally has a certain depth, such as 1.8 meters, 2.5 meters or above. Facilities such as the buffer of the elevator car, elevator stop switch, and elevator shaft light switch can usually be installed in the shaft pit.

In the case of, for example, elevator equipment malfunction, water accumulation in the pit, etc., it is generally necessary to arrange personnel to enter the shaft pit through, for example, the elevator landing door, for equipment inspection, maintenance, and other corresponding operations. Upon completion, the personnel need to unlock and open the elevator landing door from inside of the pit on one side for return. If a fixed ladder is installed inside the shaft pit, the personnel can climb up using the ladder and complete the unlocking operation of the elevator landing door. In addition, the prior art also provides other tools such as long poles, movable or foldable ladders for personnel to use when unlocking elevator landing doors.

### SUMMARY OF THE INVENTION

In view of the foregoing, the present disclosure provides an unlocking device of an elevator landing door, an unlocking method of an elevator landing door, and an elevator system, so as to solve or at least alleviate one or more of the aforementioned problems and other problems in the prior art, or to provide alternative technical solutions for the prior art.

According to one aspect of the present disclosure, an unlocking device of an elevator landing door is first provided, which comprises: a support rod; a pulley arranged on the support rod and wounded with a tension member; and an operating rod connected to a first end of the tension member, a second end of the tension member extending along a length direction of the operating rod after wounding around the pulley, wherein the operating rod is provided with an actuating portion for an operator, after operating the operating rod to cause the actuating portion to engage an unlocking member of the elevator landing door, to unlock the elevator landing door by pulling the second end of the tension member to actuate the unlocking member through the actuating portion.

In the unlocking device of an elevator landing door according to the present disclosure, optionally, the operating rod comprises a body and an extension portion which are connected and have a length extending in a longitudinal direction and a transverse direction of the operating rod respectively, and the actuating portion and the first end of the tension member are provided on the extension portion and are arranged such that when the operator operates the operating rod and the tension member to unlock the elevator landing door, a portion of the tension member located between the first end of the tension member and the pulley forms a preset angle with a portion of the tension member located between the second end of the tension member and the pulley.

In the unlocking device of an elevator landing door according to the present disclosure, optionally, the body and the extension portion are perpendicular to each other, the actuating portion is configured to be in the shape of a hook to hook the unlocking member when the operator operates the operating rod, and the preset angle is 90°.

In the unlocking device of an elevator landing door according to the present disclosure, optionally, the support rod is provided with an engaging portion configured to match at least one mating portion on a bracket provided on an inner wall of a pit of an elevator shaft, for enabling the support rod to be operably arranged in at least one position on the bracket.

In the unlocking device of an elevator landing door according to the present disclosure, optionally, the engaging portion is engaged with a first mating portion on the bracket when the unlocking device of an elevator landing door is not in use, and the engaging portion is engaged with a second mating portion on the bracket such that a plane where the pulley is located is substantially parallel to a plane where the elevator landing door is located, when the unlocking device of an elevator landing door is in use.

In the unlocking device of an elevator landing door according to the present disclosure, optionally, the engaging portion comprises a notch with an opening facing downwards, the first mating portion comprises a notch provided on a first side of the bracket with an opening facing upwards, and the second mating portion comprises a notch provided on a second side of the bracket with an opening facing upwards, the first side and the second side being perpendicular to each other.

In the unlocking device of an elevator landing door according to the present disclosure, optionally, the support rod is further provided with an assembly portion configured to fix the support rod in place on the bracket through the assembly portion after the engaging portion is engaged with the mating portion.

In the unlocking device of an elevator landing door according to the present disclosure, optionally, the support rod has a first end and a second end opposite to each other, the pulley is arranged at the first end of the support rod, the assembly portion is arranged at the second end and/or is arranged between the first end and the second end.

In the unlocking device of an elevator landing door according to the present disclosure, optionally, the unlocking device of an elevator landing door further comprises an intermediate member, the pulley is rotatably mounted on the intermediate member and fixedly connected to the support rod through the intermediate member, and/or a gripping portion is provided at the second end of the tension member.

Secondly, according to another aspect of the present disclosure, an elevator system comprising an unlocking device of an elevator landing door according to any of the above is also provided, which is arranged in a pit of the elevator shaft for an operator to unlock the elevator landing door.

In the elevator system according to the present disclosure, optionally, a bracket is provided on an inner wall of the pit of the elevator shaft, at least one mating portion is provided on the bracket, and the mating portion is configured to match the engaging portion provided on the support rod such that the support rod is operably arranged in at least one position of the bracket.

In the elevator system according to the present disclosure, optionally, the bracket comprises a first bracket and a second bracket arranged at intervals along a vertical direction of the elevator shaft, the second bracket is arranged above the first bracket, the support rod is arranged on the first bracket when the unlocking device of an elevator landing door is not in use, and the support rod is arranged on the second bracket such that a plane where the pulley is located is substantially parallel to a plane where the elevator landing door is located, when the unlocking device of an elevator landing door is in use.

In the elevator system according to the present disclosure, optionally, the engaging portion is engaged with a first mating portion on the bracket when the unlocking device of an elevator landing door is not in use, and the engaging portion is moved by the operator to be engaged with a second mating portion on the bracket such that the plane where the pulley is located is substantially parallel to the plane where the elevator landing door is located, when the unlocking device of an elevator landing door is in use.

In addition, according to another aspect of the present disclosure, an unlocking method of an elevator landing door is further provided, comprising the steps of: arranging the unlocking device of an elevator landing door according to any of the above in a pit of an elevator shaft; operating an operating rod of the unlocking device of an elevator landing door to cause the actuating portion to engage the unlocking member of the elevator landing door when the elevator landing door needs to be unlocked; and pulling the second end of the tension member of the unlocking device of an elevator landing door to unlock the elevator landing door by actuating the unlocking member through the actuating portion.

In the unlocking method of an elevator landing door according to the present disclosure, optionally, arranging the support rod of the unlocking device of an elevator landing door, when not in use, on a first bracket arranged on the inner wall of the pit of the elevator shaft, and arranging the support rod, when in use, on a second bracket arranged on the inner wall of the pit of the elevator shaft such that the plane where the pulley is located is substantially parallel to the plane where the elevator landing door is located, the second bracket being arranged above the first bracket; and/or pulling the second end of the tension member, after a preset angle between a portion of the tension member between the first end of the tension member and the pulley, and a portion of the tension member between the second end of the tension member and the pulley is formed.

By adopting the solutions of the present disclosure, it is possible to unlock an elevator landing door in a shaft pit very conveniently, efficiently, and in a time-saving and labor-saving manner. The unlocking device of the elevator landing door according to the present disclosure has the advantages of reasonable configuration, easy manufacturing and use, small space occupation, etc., can match various types of elevator landing doors, and is especially time- and labor-saving in terms of unlocking operations, thus making it convenient for operators to use in practice. The solutions of the present disclosure have strong practicality and a cost competitive advantage, which can effectively ensure the safe use of the elevator system.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system that can adopt various embodiments of the present disclosure.

FIG. 2 is a local three-dimensional structural schematic diagram of an embodiment of an unlocking device of an elevator landing door according to the present disclosure configured in the pit of an elevator shaft when not in use.

FIG. 3 is a three-dimensional structural schematic diagram of the embodiment of the unlocking device of an elevator landing door in FIG. 2, where an example of a bracket mounted on the inner wall of the pit of the elevator shaft is also shown, with the tension member omitted.

FIG. 4 is a local three-dimensional structural schematic diagram of the embodiment of the unlocking device of an elevator landing door in FIG. 2, showing structures such as the pulley, intermediate member, support rod, and tension member.

FIG. 5 is a local three-dimensional structural schematic diagram of the embodiment of the unlocking device of an elevator landing door in FIG. 2, showing the situation when the support rod is matched and engaged with the example of the bracket in FIG. 3.

FIG. 6 is a three-dimensional structural schematic diagram of the example of the bracket in FIG. 3, which also shows the connecting pieces such as bolts and nuts.

FIG. 7 is a local three-dimensional structural schematic diagram of the middle of the support rod in the embodiment of the unlocking device of an elevator landing door in FIG. 2.

FIG. 8 is a local three-dimensional structural schematic diagram when the bottom of the support rod in the embodiment of the unlocking device of an elevator landing door in FIG. 2 is assembled and fixed with the example of the bracket in FIG. 6.

FIG. 9 is a local front-view structural schematic diagram of the embodiment of the unlocking device of an elevator landing door in FIG. 2 in use for unlocking and opening the elevator landing door.

FIG. 10 is a local three-dimensional structural schematic diagram showing the situation when the embodiment of the unlocking device of an elevator landing door is used to actuate the unlocking member in the elevator landing door to unlock it in FIG. 9.

FIG. 11 is a local three-dimensional structural schematic diagram showing the situation when the embodiment of the unlocking device of an elevator landing door is used to unlock the elevator landing door, which shows the situation where the second end of the tension member is fixed in place relative to the inner wall of the pit of the elevator shaft.

FIG. 12 is a schematic diagram of the basic processing flow of an embodiment of an unlocking method of an elevator landing door according to the present disclosure.

### DETAILED DESCRIPTION OF THE INVENTION

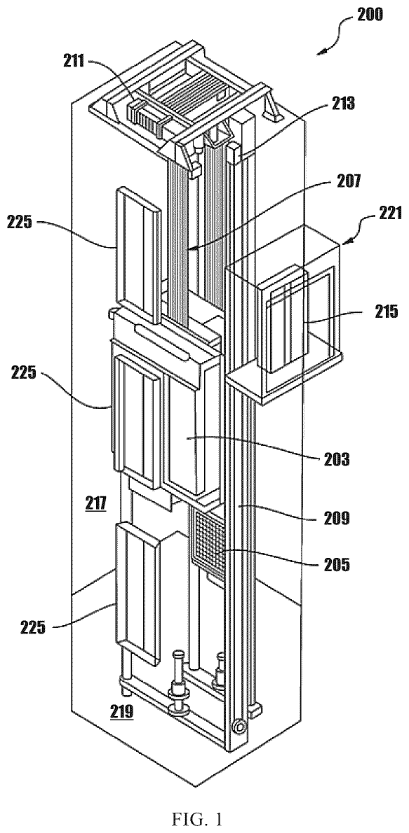

FIG. 1 is a perspective view of an elevator system 200 including an elevator car 203, a counterweight 205, a tension member 207, a guide rail (or rail system) 209, a machine (or machine system) 211, a position reference system 213, and an electronic elevator controller (controller) 215. The elevator car 203 and counterweight 205 are connected to each other by the tension member 207. The tension member 207 may include or be configured as, for example, ropes, steel cables, and/or coated-steel belts. The counterweight 205 is configured to balance a load of the elevator car 203 and is configured to facilitate movement of the elevator car 203 concurrently and in an opposite direction with respect to the counterweight 205 within an elevator shaft 217 and along the guide rail 209.

The tension member 207 engages the machine 211, which is part of an overhead structure of the elevator system 200. The machine 211 is configured to control movement between the elevator car 203 and the counterweight 205. The position reference system 213 may be mounted on a fixed part at the top of the elevator shaft 217, such as on a support or guide rail, and may be configured to provide position signals related to a position of the elevator car 203 within the elevator shaft 217. In other embodiments, the position reference system 213 may be directly mounted to a moving component of the machine 211, or may be located in other positions and/or configurations as known in the art. The position reference system 213 can be any device or mechanism for monitoring a position of an elevator car and/or counter weight, as known in the art. For example, without limitation, the position reference system 213 can be an encoder, sensor, or other system and can include velocity sensing, absolute position sensing, etc., as will be appreciated by those of skill in the art.

The controller 215 is located, as shown in FIG. 1, in a controller room 221 of the elevator shaft 217 and is configured to control the operation of the elevator system 200, and particularly the elevator car 203. For example, the controller 215 may provide drive signals to the machine 211 to control the acceleration, deceleration, leveling, stopping, etc. of the elevator car 203. The controller 215 may also be configured to receive position signals from the position reference system 213 or any other desired position reference device. When moving up or down within the elevator shaft 217 along guide rail 209, the elevator car 203 may stop at one or more landings 225 as controlled by the controller 215. Although shown in a controller room 221, those of skill in the art will appreciate that the controller 215 can be located and/or configured in other locations or positions within the elevator system 200. In one embodiment, the controller may be located remotely or in the cloud.

The machine 211 may include a motor or similar driving mechanism to provide operating power to elevator system 200, and such elevator driving devices are often referred to as traction machines, winches, etc. in practical applications. In accordance with embodiments of the present disclosure, the machine 211 can be configured to include an electrically driven motor. The power supply for the motor may be any power source, including a power grid, which, in combination with other components, is supplied to the motor. The machine 211 may include a traction sheave that imparts force to tension member 207 to move the elevator car 203 within elevator shaft 217.

Although shown and described with a roping system including tension member 207, elevator systems that employ other methods and mechanisms of moving an elevator car within an elevator shaft may employ embodiments of the present disclosure. For example, embodiments of the present disclosure may be employed in ropeless elevator systems using a linear motor to impart motion to an elevator car. Embodiments of the present disclosure may also be employed in ropeless elevator systems using a hydraulic lift to impart motion to an elevator car. Embodiments may further be employed in ropeless elevator systems using self-propelled elevator cars (e.g., elevator cars equipped with friction wheels, pinch wheels or traction wheels).

In addition, specific elevators and components are shown and described herein. FIG. 1 is merely a non-limiting example presented for illustrative and explanatory purposes. It should be noted that other elevator systems can be configured to use the unlocking device of an elevator landing door disclosed herein. Additionally, for the sake of simplification, identical or similar components and features may only be indicated in one or several locations within the same drawing.

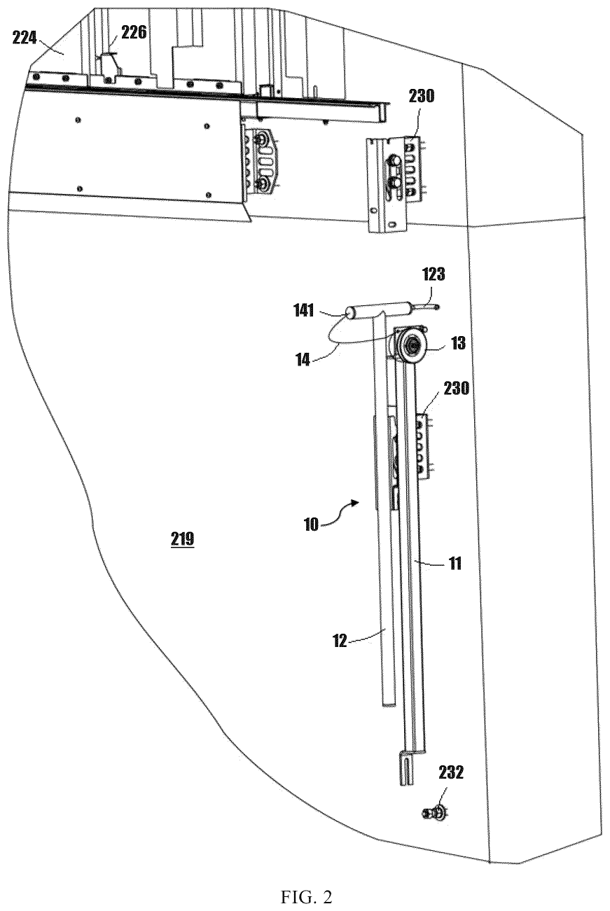

Referring to FIGS. 2, 3, and 9, the basic structure of an unlocking device of an elevator landing door 10 and the general situation of configuring it within the shaft pit 219 of the elevator system 200 are schematically shown. With the help of the unlocking device of an elevator landing door 10, the operator can unlock the elevator landing door 224 when needed.

As shown in the above figures, the unlocking device of an elevator landing door 10 may include a support rod 11, an operating rod 12, a pulley 13, a tension member 14, and an intermediate member 15. The support rod 11 and the operating rod 12 can be constructed to be substantially rod-shaped, and they can be made of any suitable material such as angle steel, aluminum profiles, plastics, etc. as needed, and can have suitable lengths and shapes that meet the specific application requirements. The support rod 11 is mainly used as a support carrier for the pulley 13, tension member 14, and other components in the unlocking device of an elevator landing door. It can be optionally arranged at a preset position on, for example, the inner wall 218 of the pit, when it is in an idle state or is in use. For example, optionally, it can be operably placed on one or more brackets 230, which will be described in detail below.

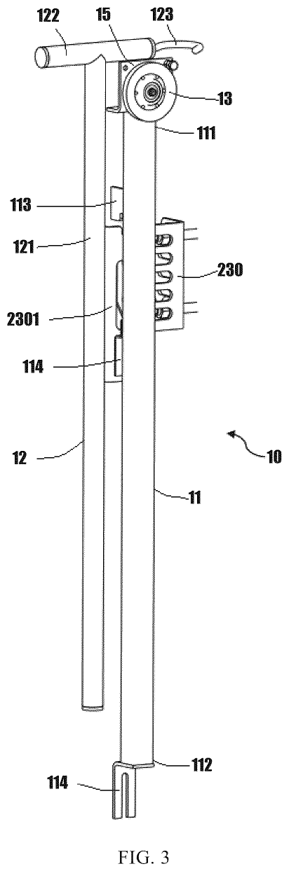

As used herein, in various embodiments, such as shown in FIG. 3, the support rod 11 may have a first end 111 and a second end 112 opposed to each other, and the pulley 13 may be mounted to the first end 111, for example, through an intermediate member 15. According to different application scenarios, the intermediate member 15 allows for any suitable shape and configuration, size, and material selection, such as being constructed into an L-shape for better installation of the pulley 13. For example, the intermediate member 15 may provide a larger support area for the pulley 13 and facilitate more stable rotation operations during use. Of course, in one or some embodiments, the present disclosure also allows for the removal of the intermediate member 15, that is, the pulley 13 may be directly mounted on the support rod 11.

With continued reference to FIGS. 2, 4, 9, 11 and other drawings, a tension member 14 is wound around the pulley 13, wherein a first end 141 of the tension member 14 can be connected to the operating rod 12, and its second end 142 can extend and hang down along the length direction of the support rod 11 after being wound around the pulley 13. Optionally, a gripping portion 143 can be arranged at the second end 142 of the tension member 14 mentioned above, so that when the operator uses the unlocking device of an elevator landing door to unlock the landing door, not only can the tension member 14 be more easily and effortlessly pulled using the gripping portion 143, but it can also be used to fix the second end 142 of the tension member 14 in position relative to the inner wall 218 of the shaft pit when needed. For example, a mating portion 232, such as a bolt, etc., that is adapted to the gripping portion 143 can be mounted on the inner wall 218, so that before the operator is ready to pull the tension member 14 to perform the unlocking operation, the gripping portion 143 can first be engaged and fixed with the mating portion 232 to facilitate the operator's subsequent pulling operation on the tension member 14, and to keep the unlocked elevator landing door open.

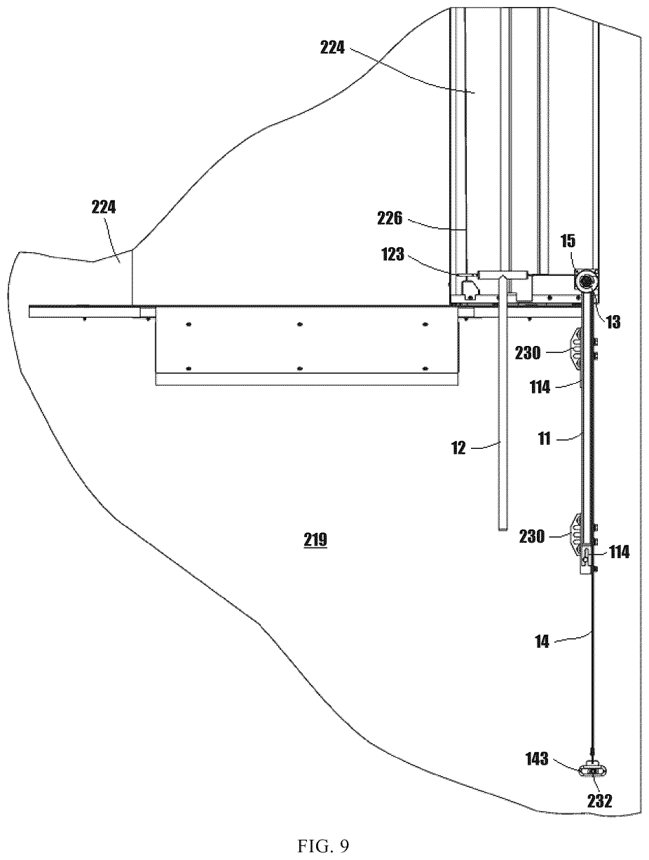

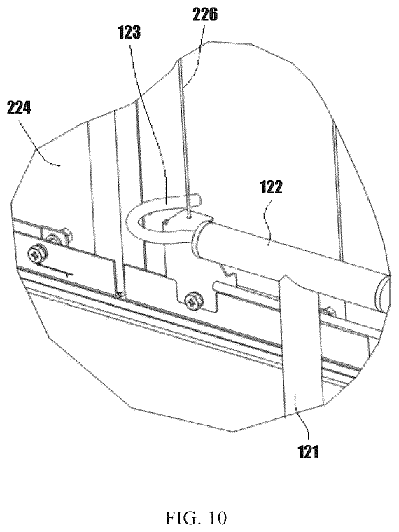

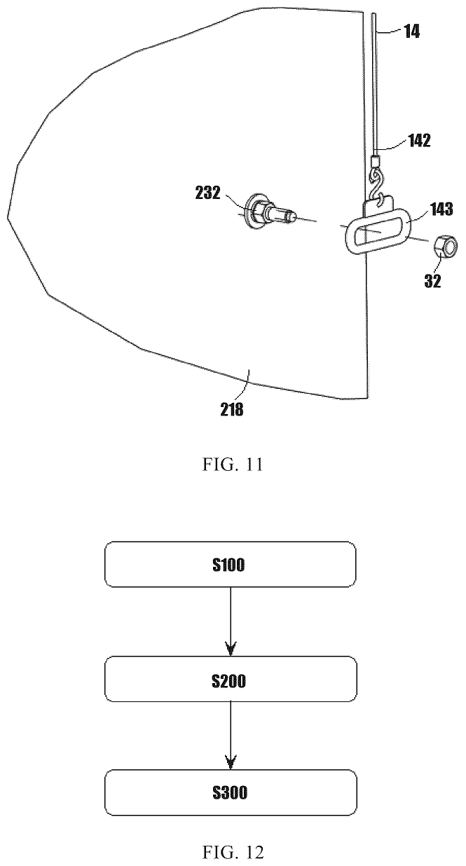

Such type of gripping portion has been illustratively described in FIGS. 9 and 11, which can have any suitable configuration such as a hook, a handle, and the like. When using the tension member 14 for pulling operation, a portion 14a of the tension member between the first end 141 and the pulley 13 can form a preset angle with a portion 14b of the tension member between the second end 142 and the pulley 13, for example, forming an angle of 90°, 85°, 80°, 95°, 100° or other suitable angles that meet the application requirements. The setting of such preset angles can facilitate the operator to apply force and save effort.

It should be noted that the tension member 14 may include, but is not limited to, ropes, steel cables, iron wires, and the like. The pulley 13 may not only be a single pulley shown as an example herein, but may also be configured in the form of a pulley set comprising two or more pulleys. The latter can help reduce the force that the operator need to apply when unlocking the elevator landing door in some application scenarios, which is conducive to making the unlocking process easier and more efficient.

The operating rod 12 is provided for the operator to operate the unlocking members configured in the elevator landing door. These unlocking members may be, for example, unlocking ropes, unlocking hooks, etc. arranged on the elevator landing door. As an example, the operating rod 12 may be configured with a body 121 and an extension portion 122, which can extend in the longitudinal and transverse directions of the operating rod 12 respectively and can be designed with appropriate lengths as needed. The body 121 and the extension portion 122 can be integrally formed or can be connected together through feasible connection means such as welding and riveting, where the present disclosure does not impose any restrictions in this regard. For example, as used herein, the extension portion 122 can be optionally constructed to be perpendicular to the body 121.

An actuating portion 123 can be arranged on the operating rod 12, so that when the operator performs corresponding operations on the operating rod 12, the actuating portion 123 will first be made to engage the unlocking portion 226 of the elevator landing door 224, and then force is applied to pull the second end 142 of the tension member 14 to actuate the unlocking portion 226 through the actuating portion 123 to unlock the elevator landing door 224. As used herein, in various embodiments, the actuating portion 123 mentioned above can be constructed in the shape of, for example, a hook, such that when the operator uses the operating rod 12 for operation, it is very convenient to hook the unlocking portion 226 and then proceed with subsequent operations.

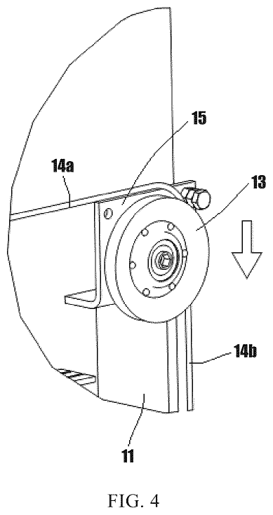

During the operating process of unlocking the elevator landing door using the operating rod 12 as mentioned above, due to the combined use of the pulley 13 and the tension member 14, the operator does not need to directly apply force to the unlocking member of the elevator landing door, such as by operating a pull rod or the like, as in solutions of the prior art. This usually requires the operator to apply a very large force in the horizontal direction parallel to the horizontal ground of the pit 219 (for example, for an existing elevator landing door, the force can reach more than 200 Newtons), which is quite laborious and it may require multiple operations to successfully unlock the elevator landing door. By contrast, when the unlocking device of an elevator landing door 10 is used, it can be optimized to apply force along the direction of gravity as shown by the arrow in FIG. 4 from the second end 142 of the tension member 14. At this point, the force can be easily applied in the vertical direction (for example, for the same elevator landing door mentioned above, only a few tens of Newtons are needed), so the elevator landing door can be unlocked in one go, thus saving time and effort.

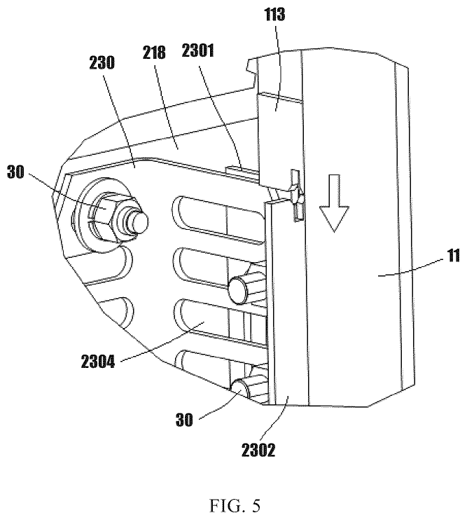

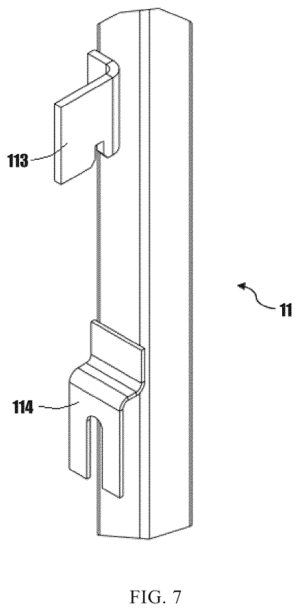

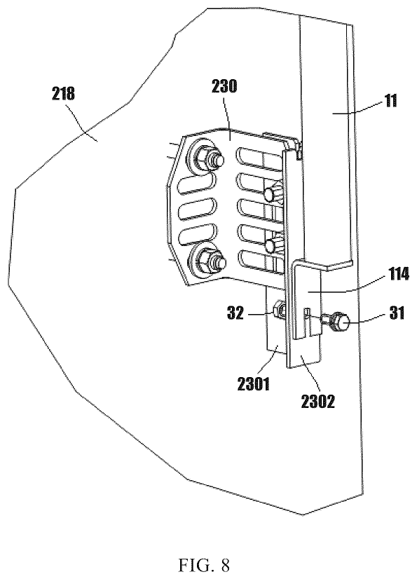

Optionally, as used herein, in various embodiments, one or more engaging portions 113 may be provided on the support rod 11 to fit with one or more mating portions mounted, for example, on the bracket 230 in the pit 219 of the elevator shaft, so that the support rod 11 can be operably arranged at one or more positions on the support 230. For example, as shown in FIGS. 3, 5-8, etc., an engaging portion 113 with a notch whose opening is facing downwards can be provided in the middle of the support rod 11. Two sides 2301 and 2302 that may be, for example, perpendicular to each other on the bracket 230 can each be provided with a notch whose opening is facing upwards to serve as the aforementioned engaging portion, so that the notch on the engaging portion 113 can be engaged with the notch on the side 2301 (or side 2302) along the direction indicated by the arrow in FIG. 5, so that the support rod 11 can be operably selected to be placed in a desired position. For example, as shown in FIG. 2, when the unlocking device of an elevator landing door is not in use (i.e., in a conventional idle state), the engaging portion 113 can be engaged with the corresponding notch on the side 2301 to place the support rod 11 in that position, and the operating rod 12 can be placed adjacent. At this point, the entire unlocking device of an elevator landing door does not need to additionally occupy the working space in the pit. For another example, as shown in FIG. 9, when the unlocking device of an elevator landing door is in use, the engaging portion 113 can be engaged with the corresponding notch on the side 2302 to place the support rod 11 in a different position from the above. At this point, it is more convenient for the operator to perform the unlocking operations for the elevator landing door. For example, it can be optionally made that the plane where the pulley 13 is located can be substantially parallel to the plane where the elevator landing door 224 is located, so that the force applied by the operator from the second end 142 of the tension member 14 can entirely or basically directly act on the unlocking portion 226, thus achieving a good effect of improving the effective force.

According to different application needs, one, two or more brackets can be mounted at suitable positions inside the pit of the elevator shaft, so as to better cooperate with the unlocking device of an elevator landing door during the unlocking operation. For example, as shown in FIGS. 2 and 9, the unlocking device of an elevator landing door 10 can be placed on a bracket 230 with a relatively low installation height when not in use, and can be adjusted to be placed on another bracket 230 with a relatively high installation height when put into use. At this point, the raised height is beneficial for the operator to unlock the elevator landing door.

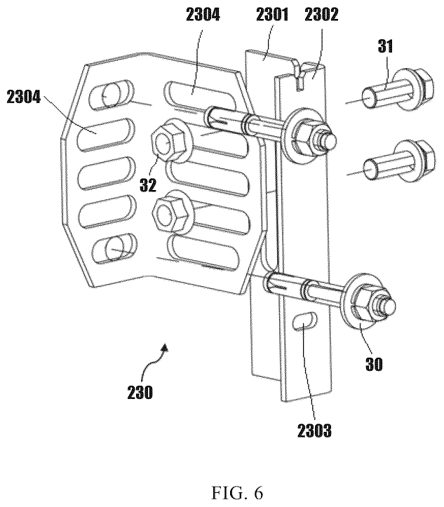

Those skilled in the art should appreciate that brackets can be configured into many feasible forms as needed. As used herein, in various embodiments, such as those shown in FIGS. 5 and 6, the bracket 230 may have multiple separate parts and be connected or fixed using connecting pieces 30 such as bolts 31, nuts 32, etc., for example, fixed to the inner wall 218 of the pit. In addition, several waist-shaped holes 2304 can be constructed on the bracket 230 for adjustment and assembling according to different application requirements, thereby having a wider range of applications and fully meeting the requirements of more occasions.

As used herein, in various embodiments, one or more assembly portions 114 may be provided at suitable positions on the support rod 11, such as in the middle of the support rod, at the second end 112, etc., so as to cooperate with the corresponding mating portions 2303 (such as mounting holes, etc.) on one or more brackets 230, thereby fixing the support rod 11 relative to the support rod 230. That is, the unlocking device of an elevator landing door can be kept in place and not easily get moved. The above methods can be carried out not only when the unlocking device of an elevator landing door is not in use, but also when it is in use. As for the former, it can better prevent the unlocking device of an elevator landing door from being lost, being damaged when falling to the ground, etc. due to various possible reasons, thus avoiding the troubles or even safety risks caused by not being able to put into use normally once needed. As for the latter, when using the device of the present disclosure to unlock the elevator landing door, since the support rod 11 has been fixed in place on the bracket 230, it can provide more stable support for the pulley 13, tension member 14, etc., which helps the operator to complete the unlocking operation in a safe, labor-saving, and efficient manner.

The basic situation of an unlocking device of an elevator landing door according to the present disclosure has been described in detail by combining several embodiments in an exemplary manner. The present disclosure further provides an unlocking method of an elevator landing door using this device. For illustration, a basic processing flow of an example of an unlocking method of an elevator landing door according to the present disclosure is shown in FIG. 12, which may include the following steps:
In step S100, the unlocking device of an elevator landing door according to the present disclosure is arranged in the pit of the elevator shaft. For example, the unlocking device of an elevator landing door can be placed on a structure, such as a bracket, mounted on the inner wall of the pit as mentioned earlier, so that the unlocking device of an elevator landing door can be conveniently obtained and put into use when needed;
In step S200, when the operator enters the pit of the elevator shaft through, for example, the elevator landing door, to perform tasks such as elevator equipment inspection and maintenance, pit drainage, etc., the elevator landing door is usually closed to ensure system safety. After the operator completes the tasks or needs to unlock the elevator landing door to return during work, the unlocking device of an elevator landing door can be obtained in the pit of the shaft, and the actuating portion can be engaged with the unlocking member for opening the elevator landing door by operating the operating rod therein;
Next, in step S300, the operator can apply a force to the second end of the tension member in the unlocking device of an elevator landing door to pull the tension member, so that the force can be transmitted through the tension member and the direction of the applied force can be changed by the pulley to drive the operating rod to move towards the direction of the pulley. This can cause the actuating portion 123 to actuate the previously engaged unlocking member to start unlocking the elevator landing door, thereby opening the elevator landing door.

Since the basic structure, working principle, and use and operation of the unlocking device of an elevator landing door have been described in detail previously, more steps to be optionally implemented for the unlocking device of an elevator landing door can be understood by referring to these contents.

For example, when the unlocking device of an elevator landing door is not in use, the support rod can be placed on the first bracket located on the inner wall of the pit. When the unlocking device of an elevator landing door is in use, the support rod can be operably adjusted and placed on another bracket, which is optionally configured, located above the first bracket. At the same time, the plane where the pulley is located can be made to be substantially parallel to the plane where the elevator landing door is located, so that it will become very easy for the operator to apply force to the tension member for the unlocking operation, thus saving time and effort.

For another example, during the unlocking operation by the operator, the portion of the tension member between the first end of the tension member and the pulley can be formed at a preset angle (i.e., substantially maintaining a 90° angle) with the portion of the tension member between the second end of the tension member and the pulley, as described earlier. This operation method can pull the second end of the tension member, thereby more effectively applying a force to the operating rod and its actuating portion, and easily unlocking the elevator landing door.

The present disclosure proposes an innovative unlocking device of an elevator landing door, the use of which makes it very convenient and time- and labor-saving to complete the unlocking operation of the elevator landing door. It is not only easy to manufacture and install, but also flexible and safe to use and operate. Compared with existing pit ladders, it has obvious cost advantages. The unlocking device of an elevator landing door according to the present disclosure has a wide range of applications and can be configured and applied to many types of elevator landing doors, so that operators can unlock the elevator landing doors when needed. The entire operation process is very fast and efficient, especially time- and labor-saving.

An unlocking device of an elevator landing door, an unlocking method of an elevator landing door, and an elevator system according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. An unlocking device of an elevator landing door, comprising:
a support rod;
a pulley arranged on the support rod and wounded with a tension member; and
an operating rod connected to a first end of the tension member, a second end of the tension member extending along a length direction of the operating rod after wounding around the pulley, wherein the operating rod is provided with an actuating portion for an operator, after operating the operating rod to cause the actuating portion to engage an unlocking member of the elevator landing door, to unlock the elevator landing door by pulling the second end of the tension member to actuate the unlocking member through the actuating portion.

2. The unlocking device of an elevator landing door according to claim 1, wherein the operating rod comprises a body and an extension portion which are connected and have a length extending in a longitudinal direction and a transverse direction of the operating rod respectively, and the actuating portion and the first end of the tension member are provided on the extension portion and are arranged such that when the operator operates the operating rod and the tension member to unlock the elevator landing door, a portion of the tension member located between the first end of the tension member and the pulley forms a preset angle with a portion of the tension member located between the second end of the tension member and the pulley.

3. The unlocking device of an elevator landing door according to claim 2, wherein the body and the extension portion are perpendicular to each other, the actuating portion is configured to be in the shape of a hook to hook the unlocking member when the operator operates the operating rod, and the preset angle is 90°.

4. The unlocking device of an elevator landing door according to claim 1, wherein the support rod is provided with an engaging portion configured to match at least one mating portion on a bracket provided on an inner wall of a pit of an elevator shaft, for enabling the support rod to be operably arranged in at least one position on the bracket.

5. The unlocking device of an elevator landing door according to claim 4, wherein the engaging portion is engaged with a first mating portion on the bracket when the unlocking device of an elevator landing door is not in use, and the engaging portion is engaged with a second mating portion on the bracket such that a plane where the pulley is located is substantially parallel to a plane where the elevator landing door is located, when the unlocking device of an elevator landing door is in use.

6. The unlocking device of an elevator landing door according to claim 5, wherein the engaging portion comprises a notch with an opening facing downwards, the first mating portion comprises a notch provided on a first side of the bracket with an opening facing upwards, and the second mating portion comprises a notch provided on a second side of the bracket with an opening facing upwards, the first side and the second side being perpendicular to each other.

7. The unlocking device of an elevator landing door according to claim 4, wherein the support rod is further provided with an assembly portion configured to fix the support rod in place on the bracket through the assembly portion after the engaging portion is engaged with the mating portion.

8. The unlocking device of an elevator landing door according to claim 7, wherein the support rod has a first end and a second end opposite to each other, the pulley is arranged at the first end of the support rod, the assembly portion is arranged at the second end and/or is arranged between the first end and the second end.

9. The unlocking device of an elevator landing door according to claim 1, wherein the unlocking device of an elevator landing door further comprises an intermediate member, the pulley is rotatably mounted on the intermediate member and fixedly connected to the support rod through the intermediate member, and/or a gripping portion is provided at the second end of the tension member.

10. An elevator system, comprising: an unlocking device of an elevator landing door according to claim 1, arranged in a pit of an elevator shaft for an operator to unlock the elevator landing door.

11. The elevator system according to claim 10, wherein a bracket is provided on an inner wall of the pit of the elevator shaft, at least one mating portion is provided on the bracket, and the mating portion is configured to match the engaging portion provided on the support rod such that the support rod is operably arranged in at least one position of the bracket.

12. The elevator system according to claim 11, wherein the bracket comprises a first bracket and a second bracket arranged at intervals along a vertical direction of the elevator shaft, the second bracket is arranged above the first bracket, the support rod is arranged on the first bracket when the unlocking device of an elevator landing door is not in use, and the support rod is arranged on the second bracket such that a plane where the pulley is located is substantially parallel to a plane where the elevator landing door is located, when the unlocking device of an elevator landing door is in use.

13. The elevator system according to claim 11, wherein the engaging portion is engaged with a first mating portion on the bracket when the unlocking device of an elevator landing door is not in use, and the engaging portion is moved by the operator to be engaged with a second mating portion on the bracket such that the plane where the pulley is located is substantially parallel to the plane where the elevator landing door is located, when the unlocking device of an elevator landing door is in use.

14. An unlocking method of an elevator landing door, comprising steps of:
arranging the unlocking device of an elevator landing door according to claim 1 in a pit of an elevator shaft;
operating an operating rod of the unlocking device of an elevator landing door to cause the actuating portion to engage the unlocking member of the elevator landing door when the elevator landing door needs to be unlocked; and
pulling the second end of the tension member of the unlocking device of an elevator landing door to unlock the elevator landing door by actuating the unlocking member through the actuating portion.

15. The unlocking method of an elevator landing door according to claim 14, wherein:
arranging the support rod of the unlocking device of an elevator landing door, when not in use, on a first bracket arranged on the inner wall of the pit of the elevator shaft, and arranging the support rod, when in use, on a second bracket arranged on the inner wall of the pit of the elevator shaft such that the plane where the pulley is located is substantially parallel to the plane where the elevator landing door is located, the second bracket being arranged above the first bracket; and/or
pulling the second end of the tension member, after a preset angle between a portion of the tension member between the first end of the tension member and the pulley, and a portion of the tension member between the second end of the tension member and the pulley is formed.
